(19) United States
(12) Patent Application Publication
(10) Pub. No.: US 2009/0056147 A1
(43) Pub. Date: Mar. 5, 2009

(54) SCISSORS AND TONGS

(76) Inventor: Han Jhong ZENG, Nantou City (TW)

Correspondence Address: Dr. BANGER SHIA, 102 Lindencrest Ct., Sugar Land, TX, 77479-5201, US

(21) Appl. No.: 11/850,086

(22) Filed: Sep. 5, 2007

(51) Int. Cl. B26B 13/04

(52) U.S. Cl. 30/260; 30/269; 30/271

(57) ABSTRACT

A pair of scissors includes a handle unit, a knife unit and a connective unit. The handle unit includes two handles. The knife unit includes two knives. Each of the knives includes two different blades. The connective unit is used to connect the first and second handles to the first and second knives in a releasable manner. Thus, a selected one of the blades of each of the knives is exposed from a related one of the handles for use.

### BACKGROUND OF INVENTION

1. Field of Invention

The present application relates to a pair of scissors or tongs and, more particularly, to a pair of scissors or tongs includes two knives or tongs each including two different blades or jaws.

2. Related Prior Art

Like any ordinary pair of scissors or tongs, a typical pair of gardening scissors or tongs includes two knives or tongs pivotally connected to each other. Each of the knives or tongs includes a handle and a blade or jaw extended from the handle. By operating the handles, a user can open or close the blades or jaws. Thus, the user can shear or pinch.

A conventional pair of gardening scissors or tongs includes two identical blades or jaws. Taking a pair of gardening scissors for example, it includes two identical blades each including a straight cutting edge. It can be used to shear thin or soft twigs. It is however difficult to use such a pair of scissors to shear thick or hard twigs since such thick or hard twigs tend to slide between the straight cutting edges.

There is another pair of scissors for shearing thick or hard twigs. This pair of scissors includes a blade with a convex cutting edge and another blade with a concave cutting edge. Thus, the concave and convex cutting edges can hold such a thick or hard twig in position while shearing the same.

As discussed above, a user must have two different pairs of scissors, one for shearing thin or soft twigs, and the other for shearing thick or hard twigs. This is however inconvenient and expensive practice.

To avoid the foregoing drawbacks, there is a pair of scissors including two knives and two handles pivotally connected to the knives. Each of the knives includes a first type of blade at one end and a second type of blade at another end. The handles can be pivoted related to the knives between a first mode and a second mode. In the first mode, the blades of the first type are used when the blades of the second type are located between the handles. In the second mode, the blades of the second type are used when the blades of the first type are located between the handles. The entire pair of scissors must be disposed of when any of the blades is broken since the blades are pivotally connected to the handles, and this is however a waste.

The present invention is therefore intended to obviate or at least alleviate the problems encountered in prior art.

### SUMMARY OF INVENTION

The primary objective of the present invention is to provide a pair of scissors including replaceable parts, thus involving a low cost in use.

According to the present invention, the pair of scissors includes a handle unit, a knife unit and a connective unit. The handle unit includes a first handle and a second handle. The first handle includes a connective portion at an end. The second handle includes a connective portion located in the connective portion of the first handle. The knife unit includes a first knife and a second knife. The first knife includes a connective portion located in the connective portion of the second handle, a first blade extended from the connective portion thereof and a second blade extended from the connective portion thereof opposite to the first blade. One of the first and second blades can selectively be inserted in the connective portion of the first handle. The second knife includes a connective portion located in the connective portion of the second handle against the connective portion of the first knife, a first blade extended from the connective portion thereof and a second blade extended from the connective portion thereof opposite to the first blade thereof. One of the first and second blades of the second knife can be inserted in the connective portion of the second handle corresponding to the first knife. The connective unit is used to pivotally connect the connective portions of the first and second knives and handles in a releasable manner.

Other objectives, advantages and features of the present invention will become apparent from the following description referring to the attached drawings.

### BRIEF DESCRIPTION OF DRAWINGS

The present invention will be described via detailed illustration of the preferred embodiment referring to the drawings.

FIG. 1 is a perspective view of a pair of scissors according to the preferred embodiment of the present invention.

FIG. 2 is an exploded view of the pair of scissors shown in FIG. 1.

FIG. 3 is an exploded view of a locking device used in the pair of scissors shown in FIG. 1.

FIG. 4 is a cross-sectional view of the pair of scissors shown in FIG. 1.

FIG. 5 is another cross-sectional view of the pair of scissors shown in FIG. 4.

FIG. 6 is a cross-sectional view of the pair of scissors in another position than shown in FIG. 4.

FIG. 7 is another cross-sectional view of the pair of scissors shown in FIG. 6.

### DETAILED DESCRIPTION OF PREFERRED EMBODIMENT

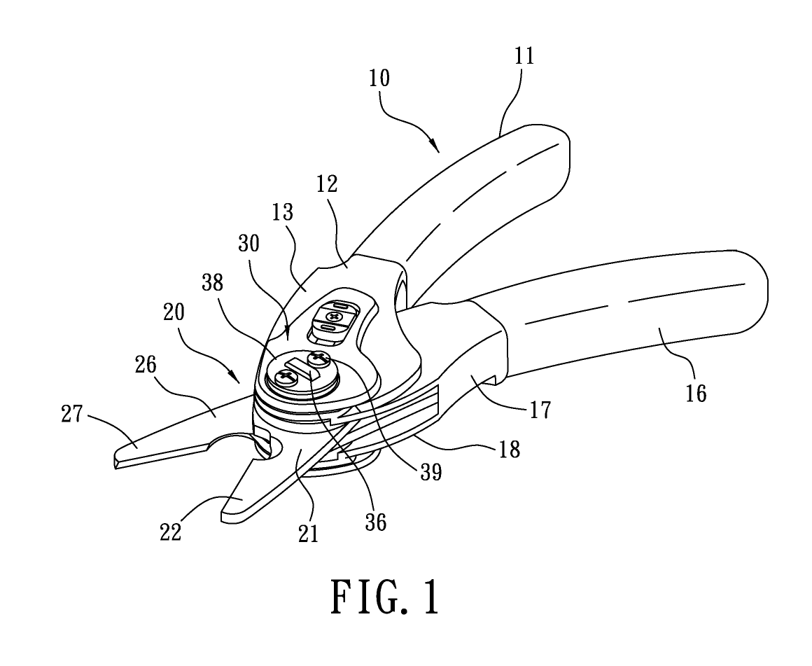

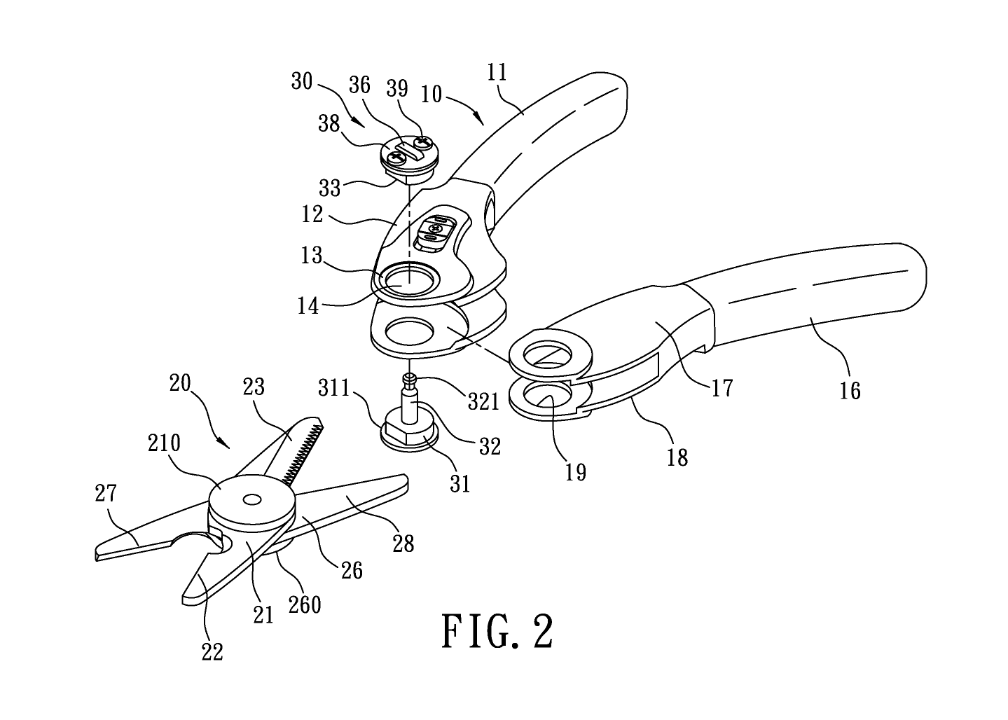

Referring to FIGS. 1 and 2, a pair of scissors includes a handle unit 10, a knife unit 20 and a connective unit 30 for connecting the handle unit 10 to the knife unit 20 according to the preferred embodiment of the present invention.

The handle unit 10 includes a first handle 11 and a second handle 16. The first handle 11 includes a connective portion 12 including two parallel ears 13 each including an aperture 14 defined therein. Similarly, the second handle 16 includes a connective portion 17 including two parallel ears 18 each including an aperture 19 defined therein.

The knife unit 20 includes a first knife 21 and a second knife 26. The first knife 21 includes a connective portion 210 and two blades 22 and 23 extended from the connective portion 210 in opposite directions. The second knife 26 includes a connective portion 260 and two blades 27 and 28 extended from the connective portion 260 in opposite directions. The connective portion 210 of the first knife 21 is pivotally connected to the connective portion 260 of the second knife 26. Although not shown, a torque spring can be provided between the connective portion 210 of the first knife 21 and the connective portion 260 of the second knife 26 so that the torque spring opens the knives 21 and 26. The blade 22 of the first knife 21 and the blade 27 of the second knife 26 are of the same type and used together. The blade 23 of the first knife 21 and the blade 28 of the second knife 26 are of the same type and used together. Although blades 22, 23, 27 and 28 of scissors are shown, they can be replaced with jaws of tongs.

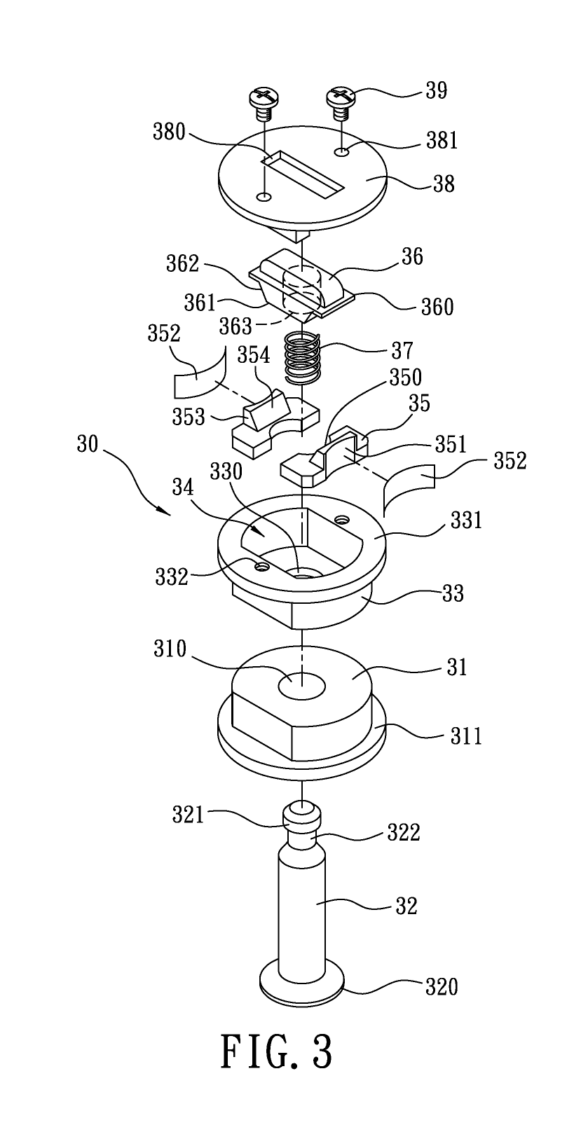

Referring to FIG. 3, the connective unit 30 includes a pivot 32, a washer 31 and a locking device. The pivot 32 includes an enlarged flat head 320 at an end, a chamfered head 321 at an opposite end and a reduced neck 322 near the chamfered head 321.

The washer 31 includes an aperture 310 defined in the center and an annular flange 311 formed on the periphery thereof. The washer 31 is shaped like a cap in the preferred embodiment. The washer 31 can however be replaced with an ordinary washer in another embodiment.

The locking device includes a casing 33, two locking elements 35, two arched leaf springs 352, a button 36 and a helical spring 37 and a cover 38. The casing 33 includes an aperture 330 defined in the center, a space 34 in communication with the aperture 330, an annular flange 331 formed on the periphery and two screw holes 332 defined in the annular flange 331. The space 34 is defined within two arched walls and two parallel straight walls.

Each of the locking elements 35 includes a concave edge 350 formed on a side, a concave face 351 formed on an opposite side and a wedge 353 formed on the top and formed with a slope 354.

The button 36 includes a flange 360 formed on the periphery and a block 361 formed on the bottom. The block 361 includes two slopes 362 formed on two opposite sides and a cavity 363 defined therein.

The cover 38 includes a slot 380 defined in the middle and two apertures 381 defined therein on opposite sides of the slot 380.

In assembly, the locking elements 35 are movably disposed in the space 34. The locking elements 35 are used like two halves of a shackle. Each of the locking elements 35 includes two parallel straight edges located near the parallel straight walls of the space 34 so that it is smoothly movable in the space 34.

The arched leaf springs 352 are disposed in the space 34. Each of the arched leaf springs 352 is compressed between the concave face 351 of a related one of the locking elements 35 and a related one of the arched walls of the space 34. Thus, the locking elements 35 are biased towards each other by the arched leaf springs 352.

The helical spring 37 includes a lower end aligned with the aperture 330 and an upper end fit in the cavity 363. The block 361 is located on the wedges 353 so that the slopes 362 are in contact with the slopes 354.

The cover 38 is provided on the casing 33 and, more particularly, the annular flange 331. The button 36 is exposed from the slot 380 while the flange 360 is pressed against the cover 38. Two threaded bolts 39 are driven in the screw holes 332 through the apertures 381, thus securing the cover 38 to the casing 33. Thus, all of the elements of the locking device are retained in the casing 33 by the cover 38.

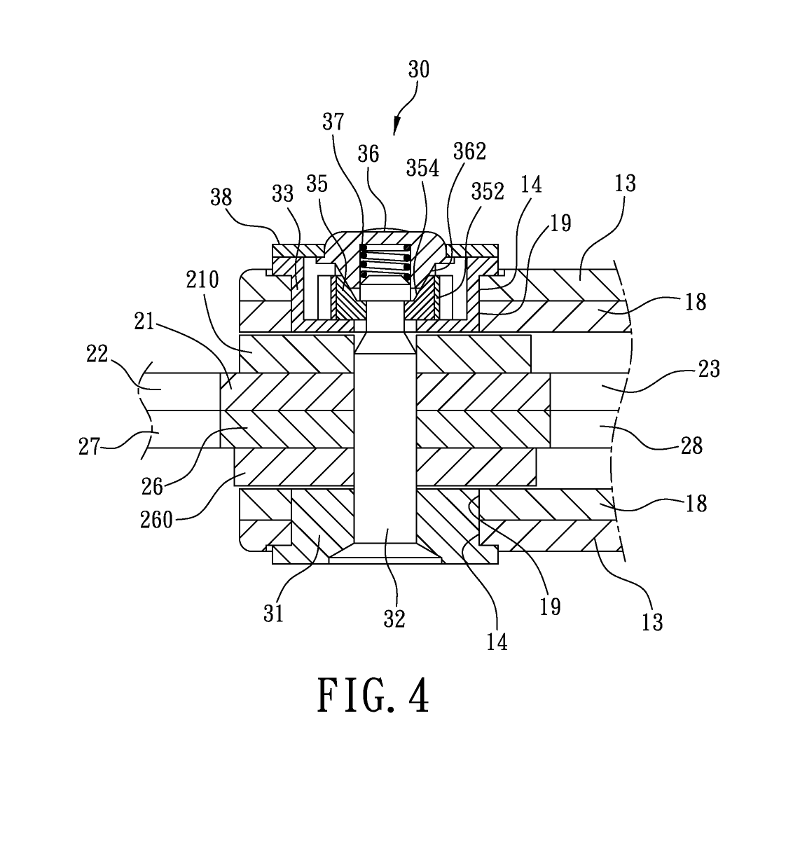

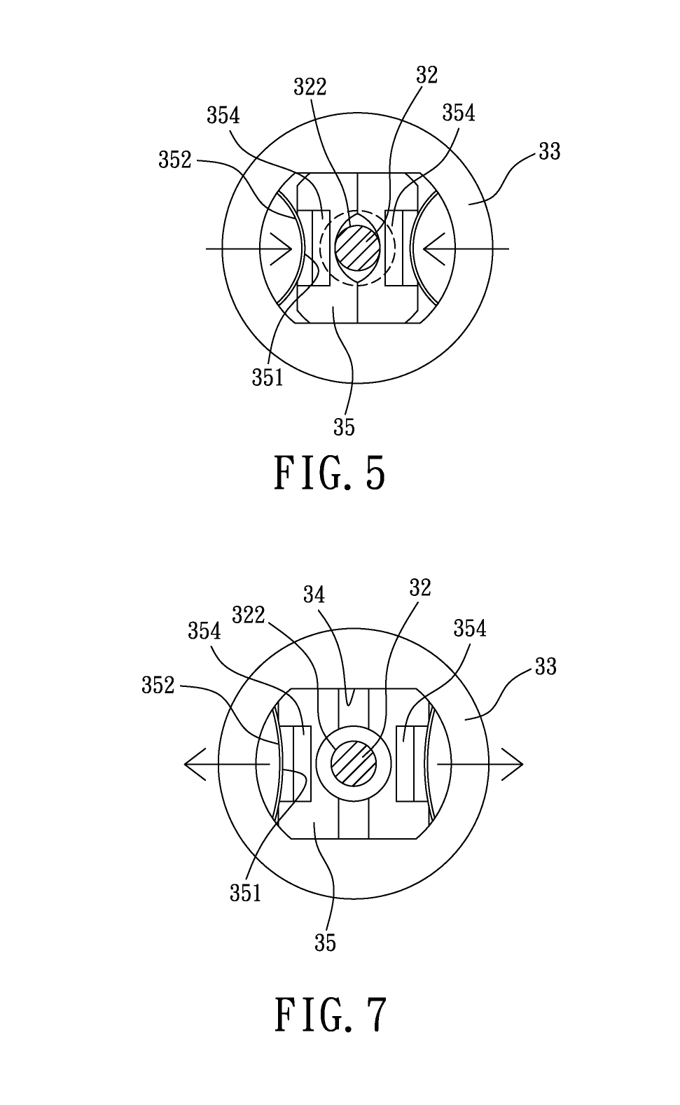

Referring to FIGS. 4 and 5, the ears 18 are located between the ears 13. The blade 23 of the first knife 21 is inserted in the first handle 11. The blade 28 of the second knife 26 is inserted in the second handle 16. The connective portion 210 of the first knife 21 and the connective portion 260 of the second knife 26 are stacked and located between the ears 18.

The casing 33 is disposed in a related one of the apertures 14 and a related one of the apertures 19 while the annular flange 331 is located against the related ear 13. The washer 31 is disposed in the other aperture 19 and the other aperture 14 while the annular flange 311 is located against the related ear 18. The pivot 32 is inserted through the apertures 310, 14 and 19, an aperture defined in the connective portion 260 of the second blade 26 and an aperture defined in the connective portion 210 of the first blade 21. The neck 322 is nipped by the concave edges 350 of the locking elements 35 so that the chamfered head 321 is restrained by the locking elements 35. The flat head 320 is pressed against the washer 31. Thus, the handle unit 10 is connected to the knife unit 20 and the connection is retained by the connective unit 30. The helical spring 37 is compressed between the chamfered head 321 and the button 36.

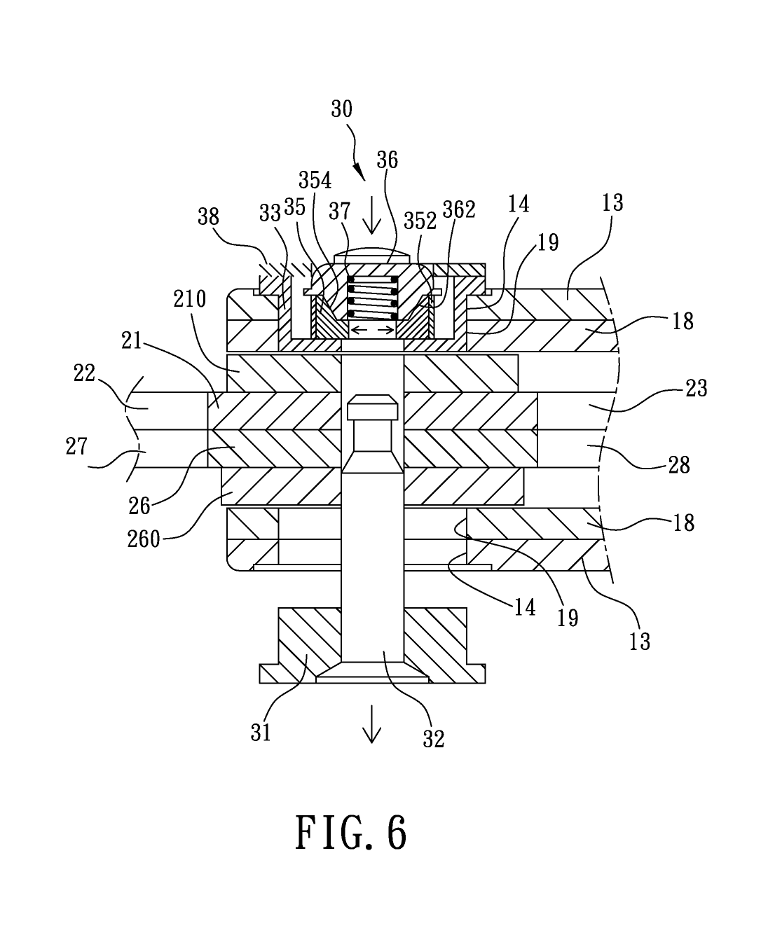

Referring to FIGS. 6 and 7, the button 36 is pressed so that the slopes 362 are moved down on the slopes 354 while the locking elements 35 are moved from each other. Thus, the neck 322 and the chamfered head 321 are free from the locking elements 35. The pivot 32 can be removed from the handle unit 10 and the knife unit 20 so that the knife unit 20 can be detached from the handle unit 10, i.e., the blade 23 of the first knife 21 and the blade 28 of the second knife 26 can be removed from the first handle 11 and the second handle 16, respectively.

The knife unit 20 can be reversed. The blade 22 of the first knife 21 and the blade 27 of the second knife 26 can be inserted into the first handle 11 and the second handle 16, respectively. The knife unit 20 can again be connected to the handle unit 10 by the connective unit 30.

The primary advantage of the pair of scissors of the present invention is a low cost in use. In specific, when one of the handles 11 and 16 or one of the knives 21 and 26 is broken, it can easily be replaced with a new one. The other parts of the scissors do not have to be disposed of.

It should be noted that the present invention can be embodied in a pair of tongs although the fore-going detailed description is directed to a pair of scissors. In such an embodiment, each of the blades 22, 23, 27 and 28 is replaced with a jaw. In another embodiment, only one of the blades 22 and 23 is replaced with a jaw while a related one of the blades 27 and 28 is replaced with a jaw. It is therefore to be understood that the term •scissors• is intended to cover scissors and tongs in the claims, and is used for briefness. Likewise, it should be understood that the term •knife• is intended to cover a knife and a tong in the claims. Similarly, it should be understood that the term •blade• is intended to cover a blade and a jaw in the claims.

The present invention has been described via the detailed illustration of the preferred embodiment. Those skilled in the art can derive variations from the preferred embodiment without departing from the scope of the present invention. Therefore, the preferred embodiment shall not limit the scope of the present invention defined in the claims.

1. A pair of scissors comprising:
a handle unit comprising:
a first handle comprising a connective portion at an end; and
a second handle comprising a connective portion located in the connective portion of the first handle;
a knife unit comprising:
a first knife comprising a connective portion located in the connective portion of the second handle, a first blade extended from the connective portion thereof and a second blade extended from the connective portion thereof opposite to the first blade, wherein one of the first and second blades can selectively be inserted in the connective portion of the first handle; and
a second knife comprising a connective portion located in the connective portion of the second handle against the connective portion of the first knife, a first blade extended from the connective portion thereof and a second blade extended from the connective portion thereof opposite to the first blade thereof, wherein one of the first and second blades of the second knife can be inserted in the connective portion of the second handle corresponding to the first knife; and
a connective unit for pivotally connecting the connective portions of the first and second knives and handles in a releasable manner.

2. The pair of scissors according to claim 1, wherein the connective portion of the first handle comprises two ears, the connective portion of the second handle comprises two ears located between the ears of the first handle, and the connective portions of the first and second knives are located between the ears of the second handle.

3. The pair of scissors according to claim 1, wherein the connective unit comprises:
a pivot comprising a first head located against the connective portion of one of the first and second handles and a second head opposite to the first head; and
a locking device located against the other handle for locking the second head of the pivot in a releasable manner.

4. The pair of scissors according to claim 3, wherein the locking device comprising:
two locking elements normally closed for restraining the second head of the pivot; and
a button that can be pressed to push open the locking elements.

5. The pair of scissors according to claim 4, wherein the locking device comprises a casing for containing the locking elements.

6. The pair of scissors according to claim 5, wherein the locking device comprises a cover for covering the casing.

7. The pair of scissors according to claim 5, wherein the locking device comprises two springs each compressed between a related one of the locking elements and a portion of the casing.

8. The pair of scissors according to claim 4, wherein each of the locking element comprises a wedge formed thereon, and the button comprises a block in contact with the wedges.

9. The pair of scissors according to claim 8, wherein each of the locking elements comprises a slope formed thereon, and the block comprises two slopes each in contact with the slope of a related one of the locking elements.

10. The pair of scissors according to claim 8, wherein the locking device comprises a spring compressed between the second head of the pivot and the block of the button.

11. The pair of scissors according to claim 10, wherein the block comprises a cavity for receiving the spring.

12. The pair of scissors according to claim 10, wherein the locking device comprises a casing for containing the locking elements, the button and the spring.

13. The pair of scissors according to claim 12, wherein the locking device comprises a cover comprising a slot defined therein so that the button is exposed from the slot when the cover is connected to the casing.
